(19) United States
(12) Patent Application Publication
(10) Pub. No.: US 2023/0321580 A1
(43) Pub. Date: Oct. 12, 2023

(54) AMBIENT AIR PURIFICATION DEVICE

(71) Applicant: MANN+HUMMEL LIFE SCIENCES & ENVIRONMENT HOLDING SINGAPORE PTE. LTD., Singapore (SG)

(72) Inventors: Jens GUSEK, Freudental (DE); Christoph SCHULZ, Stuttgart (DE); Marc HITTINGER, Reutlingen (DE)

(21) Appl. No.: 18/326,073

(22) Filed: May 31, 2023

Related U.S. Application Data
(63) Continuation of application No. PCT/IB2021/061439, filed on Dec. 8, 2021.

(30) Foreign Application Priority Data
Dec. 9, 2020 (DE) 102020132834.6

(51) Int. Cl. B01D 46/00; B01D 46/62; B01D 46/88; B01D 46/121

(52) U.S. Cl. CPC B01D 46/0005; B01D 46/62; B01D 46/88; B01D 46/121; B01D 2265/028; B01D 2259/4558; B01D 2271/022; B01D 2267/70; B01D 2221/16

(57) ABSTRACT

An ambient air purification device has a filter device arranged in a filter receiving region of its housing. The filter device has a main filter element and a prefilter element, each having a circumferential frame device. A clamping force generating device is provided in the housing to exert an axial clamping force on the frame device of the main filter element resting, when mounted, at the frame device of the prefilter element. The clamping force is transmitted to the frame device of the prefilter element and presses the latter seal-tightly via a seal against a circumferential contact shoulder of the filter receiving region to seal the filter device in the filter receiving region. The frame device of the main filter element is sealed indirectly by the frame device of the prefilter element in relation to the housing and has no seal location of its own in relation to the housing.

### CROSS-REFERENCE TO RELATED APPLICATIONS

This application is a continuation application of International Application No. PCT/IB2021/061439 filed on Dec. 8, 2021, which claims the benefit of German Application No. 102020132834.6 filed on Dec. 9, 2020, the entire disclosures of which are incorporated herein by reference for all purposes.

### BACKGROUND

The invention concerns an ambient air purification device, in particular for stationary ambient air filtration in the outdoor and/or indoor space as well as a use of a filter element in an ambient air purification device.

In many metropolitan areas worldwide, there is the problem that ambient air can surpass, by a multiple, limit values for particulate matter and/or gases such as ozone, NOx, CO caused by industrial emissions, traffic, and private heating units, in particular in case of adverse weather conditions (no rain, inversion, minimal wind speed, no air exchange between layers at different altitudes). Measures which lead to a reduction of the pollutant concentrations can either reside in avoiding or reducing emissions and/or separation of these pollutants from the ambient air.

The same problem is encountered also in indoor spaces in which, because of emission sources in the indoor space itself, persons as well as pollutant introduction from the exterior, there is a need for purifying the air.

A concept which is already documented in the prior art is the use of stationarily mounted ambient air purifiers for separation of air pollutants. Such devices comprise in general a housing, with an inlet and an outlet, which can be flowed through and in which one or a plurality of fans and a filter are arranged, wherein the filters can be typical filter elements of porous filter media permeable to air and/or electrostatic precipitators. The ambient air purifiers are installed advantageously at locations with increased pollutant concentration, for example, in the outdoor area as well as in indoor spaces, tunnels, subterranean train stations, bus stops etc.

Ambient air purifiers of this kind are, for example, disclosed in FR 27 87 175 A or US 2019/0160411 A.

In order to be able to realize a filter surface area as large as possible and thus a large separation capacity as well as a minimal pressure loss, fluidically parallel switched flat filter bellows, which are arranged in a V configuration relative to each other, are frequently used in such ambient air purifiers in practice. These filters, also referred to as V-cell filters, comprise 4 to 10 individual bellows. This is disclosed inter alia in DE 10 2018 129 286 B3.

In order to be able to fulfill the continuously increasing demand on the indoor space air quality, often so-called HEPA (high-efficiency particulate air) filters are used in ambient air purifiers. In this way, even finest particles, even certain viruses, can be filtered.

For their protection and for prolonging their service life, HEPA filters are often combined with a prefilter arranged upstream in flow direction which has a coarser fineness of filtration than the HEPA filter.

In view of this background, the present invention has the object to provide an ambient air purification device, in particular an indoor space air purifier, with at least two filter elements, wherein both filter elements, in particular HEPA filter element and prefilter element, can be exchanged independently of each other and which comprises a number of parts as low as possible.

### SUMMARY

This object is solved by an ambient air purification device, in particular for stationary ambient air filtration in the indoor and/or outdoor space, comprising:
a housing which comprises at least one air inlet and at least one air outlet, wherein in the housing at least one air flow generating device is arranged by means of which an air flow from the air inlet to the air outlet can be generated,
wherein furthermore in the housing, with respect to flow between the air inlet and the air outlet, a filter device is arranged which comprises a main filter element with a plurality of filter medium bodies arranged in a V-shape relative to each other and a prefilter element, upstream of the main filter element in regard to flow, with at least one filter medium body,
wherein the main filter element and the prefilter element each comprise a circumferentially extending frame device,
and wherein the housing comprises a filter receiving region in which the filter device is received and sealed in relation to the housing, characterized in that
the filter receiving region comprises a protruding circumferentially extending contact shoulder for seal-tight contact of a seal of the filter device,
wherein in the housing a clamping force generating device is arranged which is configured to exert, in a mounted state, an axially directed clamping force on the frame device of the main filter element,
wherein the main filter element, in the mounted state, rests at its upstream end with its frame device at the frame device of the prefilter element, wherein the clamping force can be transmitted to the frame device of the prefilter element,
and wherein the frame device of the prefilter element with interposition of a first circumferentially extending seal can be pressed by the clamping force seal-tightly against the contact shoulder,
wherein the frame device of the main filter element is sealed indirectly by the frame device of the prefilter element in relation to the housing and comprises no seal location of its own in relation to the housing.

Moreover, the object resides in providing a use of a filter element in an ambient air purification device which prevents a faulty installation of the filter element.

This object is solved by a use of a filter element as a prefilter element in an ambient air purification device according to the invention.

This object is solved by a use of a filter element as a main filter element in an ambient air purification device according to the invention

Preferred further embodiments are disclosed in the respective dependent claims.

The ambient air purification device according to the invention is embodied in particular for the stationary ambient air filtration in the indoor and/or outdoor space. It can be configured as a so-called outdoor air purifier or indoor air purifier. In an embodiment as an outdoor air purifier, it can be provided so as to be installed in the public outdoor space, for example, at inner city pollutant hotspots, for example, in the immediate vicinity of a roadway and/or in a tunnel. In the indoor space, the ambient air purification device can be used everywhere where there is a need for clean room air, for example, in offices, fabrication halls, medical facilities and/or private quarters.

The ambient air purification device has a housing which comprises at least one air inlet and at least one air outlet. In the housing, at least one air flow generating device is arranged, by means of which an air flow from the air inlet to the air outlet can be generated, wherein, furthermore, in the housing, between air inlet and air outlet with respect to flow, a filter device is present which comprises a main filter element with a plurality of filter medium bodies, which are arranged relative to each other in a V-shape, and a prefilter element arranged upstream of the main filter element with respect to flow with at least one filter medium body. The main filter element and the prefilter element each comprise a circumferentially extending frame device. The housing comprises a filter receiving region in which the filter device is received and sealed in relation to the housing. The filter receiving region comprises a protruding, circumferentially extending contact shoulder for seal-tight contact of a seal of the filter device. In the housing, a clamping force generating device is furthermore arranged which is configured to exert in a mounted state an axially directed clamping force on the frame device of the main filter element. At its upstream end, the main filter element rests with its frame device at the frame device of the prefilter element in the mounted state, wherein in this way the clamping force can be transmitted onto the frame device of the prefilter element. The frame device of the prefilter element can be pressed with interposition of a first circumferentially extending seal by the clamping force seal-tightly against the contact shoulder.

According to the invention, the clamping force is therefore introduced indirectly, i.e., with interposition of the frame device of the main filter element, into the frame device of the prefilter element. The main filter element, in turn, has no sealing location of its own in relation to the housing but seals indirectly via the frame device of the prefilter element in relation to the housing. In this way, the number of housing sealing locations is advantageously reduced which reduces the risk of leakages and permits a coarser tolerance in axial direction.

Because the main filter element has no housing sealing location of its own, the complexity and number of parts of the system is reduced.

“Protruding” means in relation to the contact shoulder in particular a radial protrusion, namely in relation to a flow cross section that spans across the frame device of the prefilter element.

An “axially directed clamping force” can also have other force components, as may result from a force attack surface of the clamping force generating device positioned at an angle to the axial direction. An “axially directed clamping force” is therefore a clamping force which comprises at least one axial component.

A frame device is understood as a mechanically stable circumferentially extending element which surrounds the filter medium body or bodies of the filter elements and in relation to which the filter medium bodies are sealed. The frame element is configured to enable a separation between an upstream raw side and a downstream clean side of the filter elements.

Main filter element and prefilter element are configured separately from each other according to the invention and are separately removable from the filter receiving region. This has the advantage that the prefilter element can be exchanged without exchanging the main filter element; this is important in practice because the service life of the main filter element is two to three times longer than that of the prefilter element.

The contact shoulder can be provided, for example, as a housing region which is reduced in cross section but also in the form of a radially circumferentially extending rib which protrudes into the filter receiving region. The contact shoulder provides an axial seal surface and has preferably an extension which is oriented (axially) in normal direction in regard to a main inflow direction.

In embodiments, the clamping force generating device can comprise a clamping bar which can be pressed by a clamping screw against the frame device of the main filter element. As an alternative or in addition, the clamping force generating device can comprises other means for generating the clamping force, for example, an elbow lever mechanism or a quick release device.

In embodiments, the housing can comprise, for example, a cuboid, in particular cube-shaped, form. However, it can also have a form deviating therefrom, for example, with a circular or elliptical base surface.

In further embodiments, the housing can comprise at least one screen which spans across the air inlet and/or the air outlet at least partially. The screen provides a hand guard and holds back coarse dirt which otherwise might damage the device for generating the air flow.

The device for generating the air flow can be an axial, diagonal or radial fan which can be driven by an electric motor. Other drive types appearing suitable to a person of skill in the art are possible.

For operating the electric motor, the filter device can comprise preferably an electrical connector. Preferably, the electrical connector can be realized at low voltage level. However, the filter device can also have devices that enable a connection at medium voltage level.

Moreover, the ambient air purification device can comprise a control device, in particular an electronic control device, with which operating times and strategies can be controlled. The control device is to be coupled to the electric motor in a manner appearing suitable to a person of skill in the art.

This V-shaped filter element configuration of the main filter element has been found to be particularly advantageous for the use in a stationary ambient air purification device because a particularly large filter surface area can be accommodated for a minimal inflow surface cross section.

Directional specifications, such as axial and radial, are to be understood herein respectively in relation to a main inflow direction which is defined by the direction of a normal vector of a plane of the prefilter element or the plane of the protruding housing-side contact shoulder.

According to a further preferred embodiment, a second circumferentially extending seal is present between the main filter element and the prefilter element and seals the frame device of the main filter element in relation to the frame device of the prefilter element.

Advantageously, the frame device of the main filter element can be sealed indirectly by the frame device of the prefilter element in relation to the housing and the frame device of the main filter element can have no sealing location of its own in relation to the housing.

In embodiments, the first as well as the second circumferentially extending seal can be present at the prefilter element, in particular at its frame device. In particular, the first and the second seal are connected to the prefilter element, in particular non-detachably connected. This has the advantage that with each exchange of the prefilter element, which must be exchanged in practice more often than the main filter element, new seals are used. This provides for a permanent reliable sealing action of the filter device in relation to the housing.

The first and/or second circumferentially extending seal can be present at a surface of a frame device which is oriented normal in relation to a main flow direction. This enables a reliable axial sealing action without shearing forces acting on the seal.

Furthermore, the housing can comprise at least one service door through which an interior of the housing is accessible, wherein through the service door in particular the filter receiving region of the housing is accessible.

This provides the advantage that a service event (exchange of the filter elements laden with dirt) can be realized significantly faster and more ergonomically with respect to the workflow.

As an alternative or in addition, a length extension of the plurality of filter medium bodies of the main filter element which are arranged in a V-shape relative to each other can extend in a horizontal direction in a predetermined operating orientation of the ambient air purification device.

In this case, one speaks of a lying arrangement of the filter medium bodies. In other embodiments, an arrangement of the filter medium bodies deviating therefrom is possible also, for example, an orientation of the length extensions of the filter medium bodies in vertical direction, i.e., upright.

A length extension is understood as an extension direction of the filter medium body which coincides with the spatial direction in which the latter has its largest dimension.

According to a further preferred embodiment, at least one of the filter medium bodies of the prefilter element and/or of the main filter element can comprise a folded bellows of folded filter medium. In particular, the prefilter element as well as the main filter element comprise at least one filter medium body with a folded bellows of a folded filter medium.

A further embodiment provides that the housing comprises front and rear walls, side walls as well as top and bottom walls, which are positioned opposite each other, respectively. The air outlet is positioned in particular in a front or rear wall and the air inlet in a side wall. Optionally, an air flow between air inlet and air outlet can experience at least one directional change in regard to its main flow direction, in particular by 90°.

In embodiments, at least one partition can be arranged in the housing and separates the filter receiving region from a fan receiving region. In particular, the air flow generating device can be held at the partition and a fluid connection between the filter receiving region and the fan receiving region can exist. The accommodation of the air flow generating device, in particular of a motor and/or fan wheel of the air flow generating device, in a separated fan receiving region has further acoustic advantages.

In embodiments, the housing can comprise at least an acoustic damping element. Preferably, the housing is lined at the inner side with an acoustic material, in particular a damping foam or nonwoven, in the region of the fan receiving region. This measure can significantly lower the operating noise level.

The filter receiving region provides a clean air region which is separated by the sealing contact of the first circumferential seal between the prefilter element and the contact shoulder of the housing from a raw air region arranged outside.

In embodiments, the frame device at least of the prefilter element or of the main filter element, preferably however both, can be comprised of, or comprise, a material which is rigid in compression, preferably of a plastic material or steel material.

The frame device is preferably fluid-tightly connected to the respective filter medium body, in particular to the end face edges of the folds of the folded bellows as well as to head edges of the folded bellows. The frame device can comprise in particular a hard plastic component which is injection-molded to the folded bellows or can be connected in other ways to the filter medium body, for example, glued or foamed.

In another also preferred embodiment, the frame device of the main filter element can comprise a radially projecting, circumferentially extending collar at which the clamping force generating device attacks in the mounted state.

In embodiments, at least one of the filter elements can comprise at least one particle filter medium, preferably a HEPA filter medium, and/or at least one adsorbent, in particular an active carbon/or a zeolite. As an alternative or in addition, the filter elements or their respective frame devices can comprise a polygonal, in particular cuboid, form.

Preferably, the main filter element comprises the HEPA filter medium and the prefilter element a “coarser” particle filter medium.

The particle filter medium can comprise a spunbond nonwoven material, in particular a polyethylene terephthalate or polypropylene spunbond nonwoven material, and/or a needled nonwoven material, in particular a polypropylene or polyethylene terephthalate needled nonwoven, and/or a meltblown layer and/or a multi-component fiber material, in particular with bicomponent fibers with a polypropylene/polyacrylonitrile component.

The HEPA filter medium comprises in particular at least one membrane layer of an expanded PTFE. Preferably, the HEPA filter medium is certified according to ISO 29463 and EN 1822 and fulfills the requirements of class H13 or H14.

The adsorbent can serve for adsorption of predetermined harmful gases, for example, NOx, CO, NH3 and/or odors. The adsorbent can be in particular part of the filter medium and can be present as a loose fill in the form of one layer or several layers.

Preferably, the prefilter element comprises a filter medium with an adsorbent.

According to yet another embodiment, the filter medium of at least one of the filter elements can comprise at least one further layer which is configured as an antimicrobial and/or antiallergic layer which comprises at least one antimicrobial and/or antiallergic substance. Due to this measure, the ambient air quality can be improved in regard to a further important aspect.

The antimicrobial, in particular antibacterial or biocidal, substance protects the filter medium or parts or layers thereof from becoming contaminated with microorganisms such as fungi or fungal spores, in particular mold or mold spores, bacteria or algae which may be present in living, reproductive or propagable form, or from such microorganisms spreading in or growing through the filter medium.

For example, the antiallergic substance can at least partially render innocuous to the human body or its immune system finest pollen particles and other allergens which cannot always be completely retained by the filter medium.

Zinc pyrithione can serve as antimicrobial substance, for example. As an alternative or in addition, octa-isothiazolone can be used as antimicrobial substance. The second filter layer can contain furthermore antimicrobial substances on the basis of nanosilver. The second filter layer can also contain antimicrobial metals and metal compounds, in particular silver, copper, and aluminum compounds, and/or 2-bromo-2-nitropropane-1,3-diol, further isothiazolone compounds, benzoic acid and its derivatives, benzalkonium halides, water-soluble coenzymes, oil-soluble coenzymes, plant extracts, antibiotics, biocidal metals, aliphatic and/or aromatic fatty acids and/or quaternary surfactants as antimicrobial substances.

As antiallergic substances, in particular polyphenols, such as catechins, tannides or flavonoids, are conceivable. In particular, caffeic acid, gallic acid, ellagic acid, tannic acid, cyanidin, procyanidin, proanthocyanidins, rutin, quercetin, resveratrol can be used. Polyphenols bind preferably allergenic substances so that the allergic effect can be reduced. Allergenic pollen are denatured, for example, by polyphenols. The antiallergic substance can furthermore comprise antiallergic enzymes. Antiallergic enzymes cleave preferably proteins which act as an allergen into smaller innocuous components.

Further preferred, it can be provided that the filter device is arranged at the suction side with respect to the air flow generating device. This reduces the operating noise level and enables a less complex sealing action of the housing because a relative vacuum in relation to the ambient is present in a large portion of the housing.

A further embodiment provides that the main filter element comprises at least four, preferably at least six, filter medium bodies which are arranged in a V-shape relative to each other, respectively. This is also referred to as a V-cell configuration. The filter surface area of an individual filter medium body in the form of a folded filter bellows can amount to 0.5 m² to 3.5 m², preferably 1.7 m² to 2.7 m², by employing a non-HEPA particle filter medium.

When using a HEPA filter medium, the filter surface area per filter medium body can even amount to 4 m²-7 m² because a HEPA filter element in general is significantly thinner than other filter media.

The dimensions of the individual filter medium bodies of the V-cell element of the main filter element (in form of folded filter bellows) can be designed in an exemplary fashion as follows:
length:250 mm-800 mm
width:250 mm-600 mm
height:20 mm-50 mm
fold height:20 mm-50 mm
fold spacing:3 mm-10 mm

In embodiments, the ambient air purification device according to the invention can comprise a third filter element which is arranged downstream of the main filter element in respect to flow. In particular, the third filter element comprises at least one adsorbent, in particular an active carbon. In this context, the third filter element can be arranged upstream or downstream of the air flow generating device. The adsorbent of the third filter element can be a different adsorbent than an adsorbent which is provided in the prefilter element. In this way, advantageously specific target gas spectra can be covered optimally. The third filter element comprises in particular a filter medium folded to a filter bellows and a frame device circumferentially extending around the filter bellows. It can be arranged in a manner appearing suitable to a person of skill in the art downstream of the main filter element. In this context, it is also possible that the third filter element is flowed through or bypassed in partial flow or bypass flow.

A further aspect of the invention concerns respectively the use of a filter element as prefilter element and as main filter element in an ambient air purification device according to the invention.

The features and feature combinations disclosed in relation to the ambient air purification device as well as their advantages can be applied to the uses according to the invention, and vice versa.

### BRIEF DESCRIPTION OF DRAWINGS

Further advantages result from the following drawing description. In the drawings, embodiments of the invention are illustrated. The drawings, description, and claims contain numerous features in combination. A person of skill in the art will consider the features expediently also individually and combine them to expedient further combinations.

FIG. 1 shows an isometric illustration of the ambient air purification device according to the invention.

FIG. 2 shows a further isometric illustration of the ambient air purification device according to the invention.

FIG. 3, FIG. 4, FIG. 5, FIG. 6, and FIG. 7 show isometric illustrations of the servicing of the ambient air purification device according to the invention, respectively.

FIG. 8 shows a longitudinal section of the ambient air purification device according to the invention.

FIG. 9 shows a detail A of FIG. 8.

### DETAILED DESCRIPTION

In the Figures, same or same-type components are identified with same reference characters. The Figures show only examples and are not to be understood as limiting.

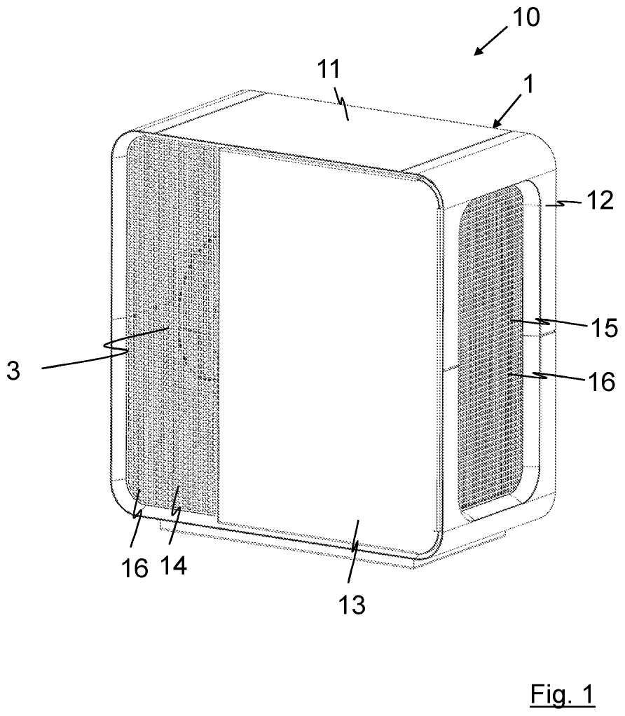

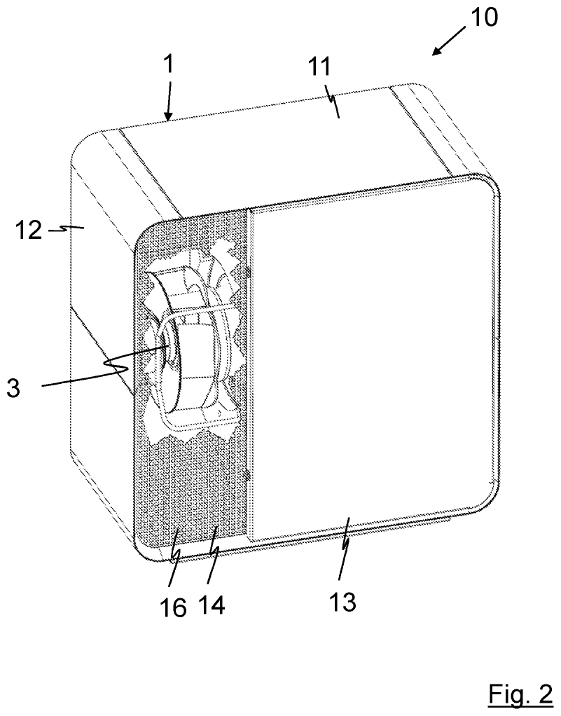

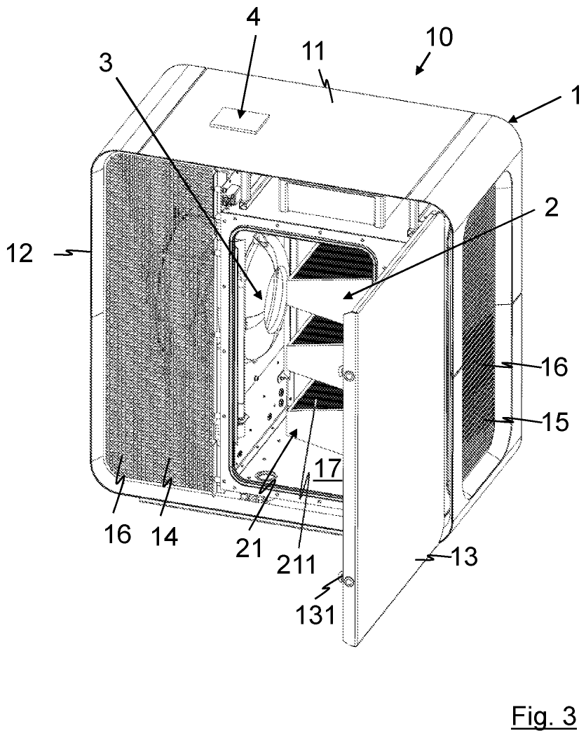

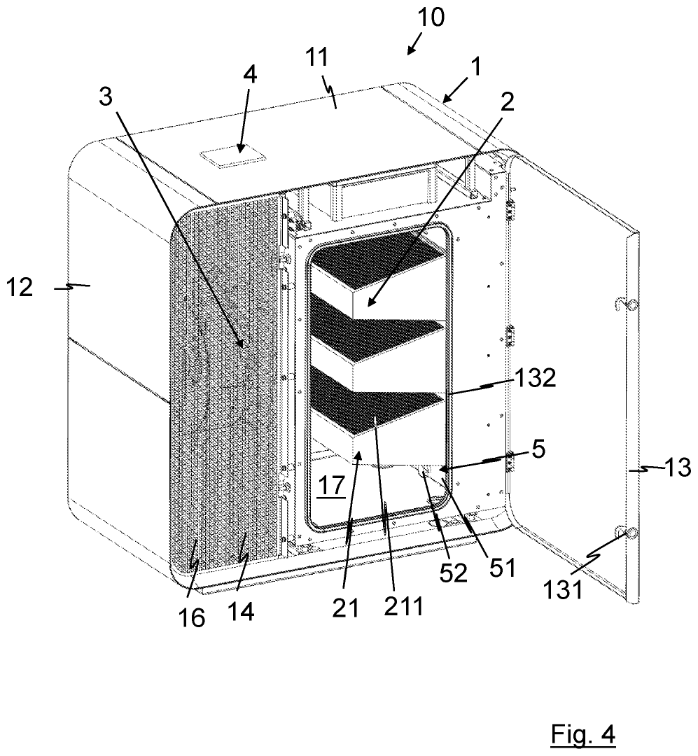

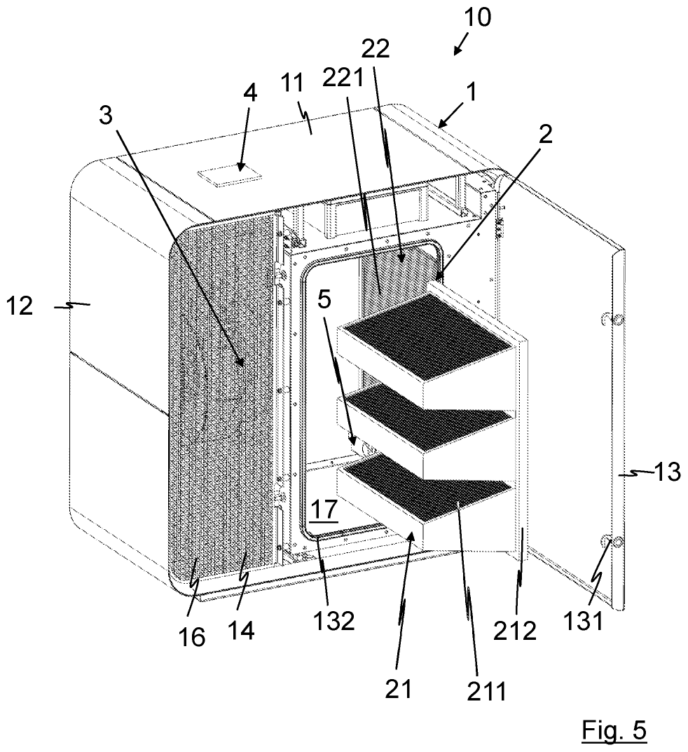

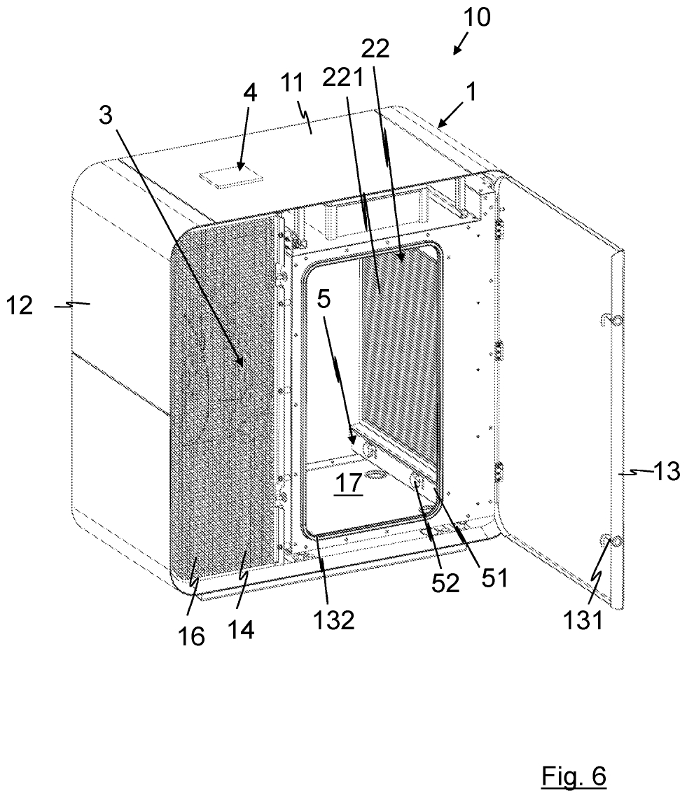

The ambient air purification device 10 according to the invention and illustrated in FIG. 1 in an isometric external view comprises a housing 1 which comprises an air inlet 15 as well as an air outlet 14. The air inlet 15 and the air outlet 14 are each spanned across by a screen 16 which guards against access to the interior of the housing 1 and keeps away other foreign bodies. The housing 1 according to this embodiment has a substantially cuboid shape and comprises side walls 12 as well as a top and a bottom wall 11, respectively. The housing 1 comprises rounded edges that minimize the risk of injury, which is in particular advantageous in case of an indoor installation of the device according to the invention. Rounded edges are respectively provided at the short edges of the cuboid shape. The air inlet 15 is provided in a side wall 12 and the air outlet 14 in a front wall. Between the air inlet 15 and the air outlet 14 in regard to flow, a filter device 2 as well as an air flow generating device 3, which is configured to generate an air flow from the air inlet 15 through the filter device 2 to the air outlet 14, are arranged in the housing 1 (see FIGS. 2 and 3). The air flow generating device 3 of the illustrated ambient air purification device 10 is a radial fan which is driven by an electric motor. The ambient air purification device 10 according to the invention comprises furthermore a service door 13 which can be opened for servicing.

The air flow generating device 3 comprises a fan (fluid flow engine) as well as an electric motor which drives the fan. The fan can be designed by a person of skill in the art as a function of the system characteristic line, wherein in particular known configurations such as axial fans, diagonal fans, and radial fans are conceivable.

In embodiments, the ambient air purification device 10 comprises a control device 4. The control device 4 can be in particular an electronic control device which can control operating times and strategies. The control device 4 is to be coupled in a manner appearing suitable to a person of skill in the art to the electric motor. As an alternative, the electric motor of the air flow generating device 3 can also be actuated by a simple switch.

The service event for exchange of the filter element 2 as well as further details of the ambient air purification device 10 are illustrated in FIGS. 3 to 7 in a detailed manner with the open service door 13.

The service door 13 is pivotably connected and, in the closed state, is sealed by a seal 132 which circumferentially extends around the service opening of the housing 1. In its closed state, the service door 13 can be locked relative to a housing body by lock means 131 and is opened for the service event.

The housing 1 comprises a filter receiving region 17 in which a filter device 2 comprising a main filter element 21 and a prefilter element 22 (see FIGS. 5 to 9) is arranged. The main filter element 21 comprises a plurality of filter medium bodies 211, here six of them, arranged relative to each other in a V-shape. The filter medium bodies 211 can be in particular filter bellows of a folded filter medium. The main filter element 21 comprises in particular a HEPA filter medium.

In FIG. 4, the attachment of the filter elements 21, 22 in the filter receiving region 17 of the housing 1 can be seen. The main filter element 21 is clamped in the housing 1 by a clamping force generating device 5 which exerts an axial clamping force on its frame device 212 (see FIG. 5). The clamping force generating device 5 comprises a clamping bar 51 which can exert, by means of one or a plurality of clamping screws 52, a clamping force on the frame device 212 of the main filter element 21. FIG. 4 shows in this context the mounted state, i.e., a state with mounted/clamped filter elements 21, 22.

For exchange of the filter elements 21, 22, the clamping screws 52 are released and the clamping bar 51 can be radially displaced by means of an L-shaped cutout in the clamping bar 51, which is associated with the clamping screws 52, respectively, and through which the clamping screws 52 are guided, respectively, so that the clamping engagement of the clamping bar 51 on the frame device 212 of the main filter element 21 is released and the latter can be removed from the housing 1, as can be seen in FIG. 5.

The end of the main filter element 21 shown to the right in the drawing is its upstream end and the end to the left in the drawing is its downstream end. At its upstream side, the main filter element 21 has arranged upstream thereof a prefilter element 22 which also comprises a filter bellows of a folded filter medium and serves as protection for the main filter element 21 and prevents a premature excessive loading of the main filter element 21.

The prefilter element 22 comprises a frame device 222 which surrounds circumferentially the filter medium body 221. At a downstream side of the frame device 222 (in the drawing to the left), a second circumferentially extending seal 223 is provided by means of which, in the mounted state, the frame device 222 of the prefilter element 22 is sealed in relation to the frame device 212 of the main filter element 21. The sealing action between the frame device 222 of the prefilter element 22 and the frame device 212 of the main filter element 21 is realized axially.

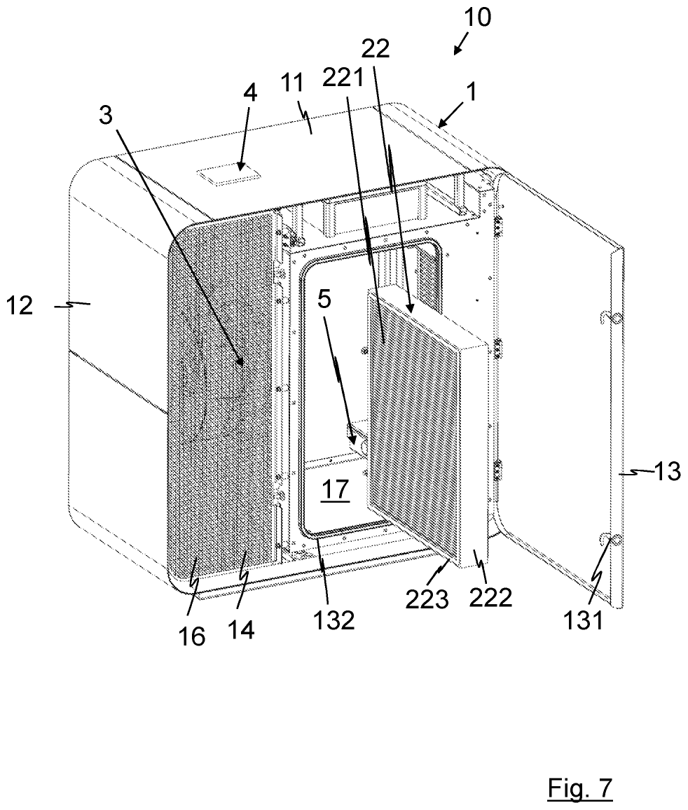

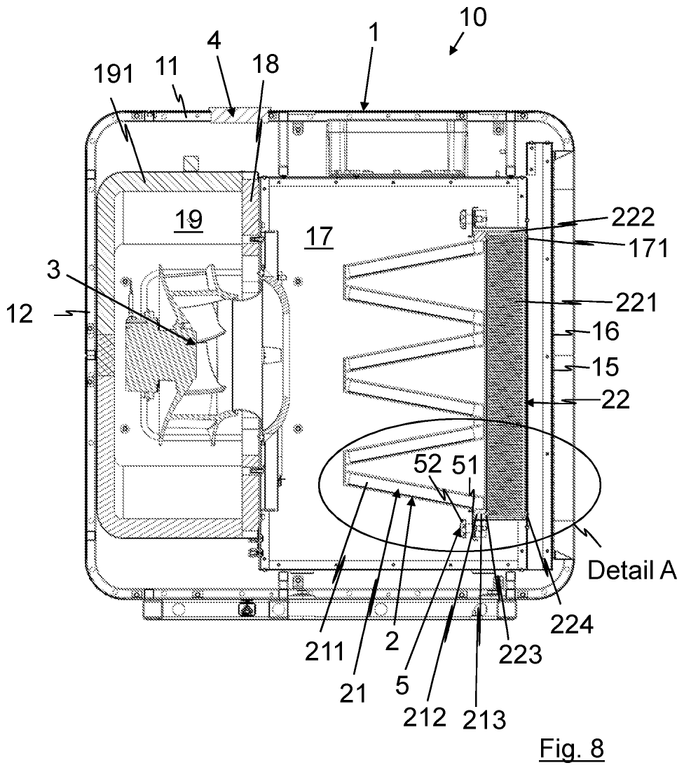

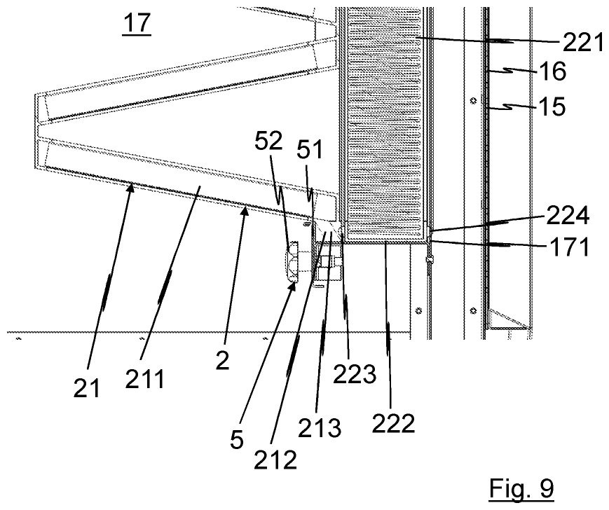

In FIGS. 8 and 9, the interface of the prefilter element 22 and the main filter element 21 in relation to the housing 1 is shown in longitudinal section views which show the mounted state of the ambient air purification device 10. FIG. 9 shows in this context detail A of FIG. 8.

It can be seen that the main filter element 21 has no sealing device “of its own” in relation to the housing 1 but is sealed indirectly through the first circumferentially extending seal 224 which is present between the frame device 222 of the prefilter element 22 and the protruding contact shoulder 171 of the housing 1.

By means of the clamping force generating device 5, an axially directed clamping force is exerted on the frame device 212 of the main filter element 21. At its upstream end, the frame device 212 of the main filter element 21 rests at the frame device 222 of the prefilter element 22 with interposition of a second circumferentially extending seal 223, whereby the clamping force is transmitted to that of the frame device 222 of the prefilter element 22 and the frame device 212 of the main filter element 21 is sealed in relation to the frame device 222 of the prefilter element 22.

The frame device 222 of the prefilter element 22 rests at its end which is facing away from the main filter element 21, i.e., with its upstream side (in the drawing to the right), with interposition of the first circumferentially extending seal 224 at a protruding circumferentially extending contact shoulder 171 of the filter receiving region 17 of the housing 1 and is compressed by the clamping force in relation to the contact shoulder 171. The actual sealing contact of the filter device 2 is produced in the axial sealing contact between the first circumferentially extending seal 224 and the contact shoulder 171.

In an embodiment of the invention, the first circumferentially extending seal 224 as well as the second circumferentially extending seal 223 are arranged at the prefilter element 22. This has the advantage that with each exchange of the prefilter element 22, which in practice must be exchanged more frequently than the main filter element 21, new seals 224, 223 are used. This provides a permanent reliable sealing action of the filter device 2 in relation to the housing 1. However, embodiments are also in accordance with the invention in which the first seal 224 and/or second seal 223 are not connected to the prefilter element 22 and are provided loose.

The frame device 212 of the main filter element 21 has a circumferentially extending collar 213 which projects radially and provides the force introduction surface for the clamping force generating device 5.

The indirect sealing action of the main filter element 21 according to the invention in relation to the housing 1 has the advantage that the main filter element 21 requires no sealing location of its own in relation to the housing 1. In this way, the number of housing seal parts is reduced which reduces the risk of leakages and provides for a coarser tolerance in axial direction.

Furthermore, the prefilter element 22 can be exchanged without exchanging the main filter element 21 which is in practice relevant because the service life of the prefilter element 22 is two to three times longer than that of the main filter element 21.

For enabling this advantageous interface concept, the frame devices 212, 222 of the filter elements 21, 22 must have a sufficiently high compressive strength so that the forces required as a result of the sealing reaction forces can be transmitted without causing failure of the frame devices 212, 222. Therefore, the frame devices 212, 222 are produced preferably of a (hard) plastic material or steel material.

Within the housing 1, a partition 18 is provided which separates the filter receiving region 17 from a fan receiving region 19. The partition comprises a through opening which enables a fluid connection of the filter receiving region 17 to the fan receiving region 19 and carries the air flow generating device 3 which is arranged in the through opening. The fan receiving region 19 is lined with an acoustic damping material 191 which significantly lowers the operating noise level of the ambient air purification device 10.

1. An ambient air purification device comprising:
a housing comprising at least one air inlet and at least one air outlet;
at least one air flow generating device arranged in the housing and configured to generate an air flow from the air inlet to the air outlet;
a filter device arranged in the housing between the air inlet and the air outlet in relation to the air flow, the filter device comprising a main filter element that comprises a plurality of filter medium bodies arranged in a V-shape relative to each other, and a prefilter element arranged upstream of the main filter element in regard to the air flow and comprising at least one filter medium body,
wherein the main filter element comprises a circumferentially extending frame device,
wherein the prefilter element comprises a circumferentially extending frame device,
wherein the housing comprises a filter receiving region, and
wherein the filter device is arranged in the filter receiving region comprising a protruding circumferentially extending contact shoulder;
a clamping force generating device arranged in the housing and configured to exert, in a mounted state of the filter device, an axially directed clamping force on the circumferentially extending frame device of the main filter element,
wherein, at an upstream end of the main filter element, the circumferentially extending frame device of the main filter element, in the mounted state of the main filter element, rests at the circumferentially extending frame device of the prefilter element, and
wherein the axially directed clamping force is transmitted to the circumferentially extending frame device of the prefilter element; and
a first circumferentially extending seal interposed between the circumferentially extending frame device of the prefilter element and the protruding circumferentially extending contact shoulder of the filter receiving region,
wherein the circumferentially extending frame device of the prefilter element is pressed by the axially directed clamping force via the first circumferentially extending seal seal-tightly against the protruding circumferentially extending contact shoulder of the filter receiving region to seal the filter device in relation to the housing, and
wherein the circumferentially extending frame device of the main filter element is sealed indirectly by the circumferentially extending frame device of the prefilter element in relation to the housing and comprises no seal location of its own in relation to the housing.

2. The ambient air purification device according to claim 1, further comprising a second circumferentially extending seal arranged between the main filter element and the prefilter element, the second circumferentially extending seal sealing the circumferentially extending frame device of the main filter element in relation to the circumferentially extending frame device of the prefilter element.

3. The ambient air purification device according to claim 2, wherein the first circumferentially extending seal and the second circumferentially extending seal are arranged at the prefilter element or at the circumferentially extending frame device of the prefilter element.

4. The ambient air purification device according to claim 2, wherein the second circumferentially extending seal is arranged at a surface of the circumferentially extending frame device of the prefilter element and/or of circumferentially extending frame device of the main filter element, and
wherein said surface is oriented normal in relation to a main inflow direction of the air flow.

5. The ambient air purification device according to claim 1, wherein the first circumferentially extending seal is arranged at a surface of the circumferentially extending frame device of the prefilter element, and
wherein said surface is oriented normal in relation to a main inflow direction of the air flow.

6. The ambient air purification device according to claim 1, wherein the housing comprises at least one service door, through which an interior of the housing or the filter receiving region is accessible.

7. The ambient air purification device according to claim 1, wherein a length extension of the plurality of filter medium bodies of the main filter element extends in a horizontal direction in a predetermined operating orientation of the ambient air purification device.

8. The ambient air purification device according to claim 1, wherein at least one of the filter medium bodies of the prefilter element and/or at least one of the plurality of filter medium bodies of the main filter element comprises a folded bellows of a folded filter medium.

9. The ambient air purification device according to claim 1, wherein the housing comprises:
a front wall and a rear wall positioned opposite each other;
side walls positioned opposite each other; and
a top wall and a bottom wall positioned opposite each other,
wherein the air outlet is arranged in the front wall or the rear wall,
wherein the air inlet is arranged in one of the side walls, and
wherein a main flow direction of the air flow between the air inlet and the air outlet experiences at least one directional change in a main flow direction.

10. The ambient air purification device according to claim 1, further comprising at least one partition arranged in the housing and separating the filter receiving region from a fan receiving region,
wherein the air flow generating device is arranged in the fan receiving region,
wherein the air flow generating device is held at the partition, and
wherein a fluid connection between the filter receiving region and the fan receiving region exists.

11. The ambient air purification device according to claim 1, wherein the filter receiving region comprises a clean air region.

12. The ambient air purification device according to claim 1, wherein the circumferentially extending frame device at least of the prefilter element or at least of the main filter element is comprised of, or comprises, a material rigid in compression.

13. The ambient air purification device according to claim 12, wherein the material rigid in compression is a plastic material or a steel material.

14. The ambient air purification device according to claim 1, wherein the circumferentially extending frame device of the main filter element comprises a radially projecting circumferentially extending collar, and
wherein the clamping force generation device attacks at the radially projecting circumferentially extending collar in the mounted state of the filter device.

15. The ambient air purification device according to claim 1, wherein at least one of the main filter element and the prefilter element comprises one or more features selected from the group consisting of a particle filter medium, an adsorbent, an antimicrobial finish, an antibacterial finish, and an antiviral finish.

16. The ambient air purification device according to claim 15, wherein the particle filter medium is a HEPA filter medium, and
wherein the adsorbent is an active carbon and/or a zeolite.

17. The ambient air purification device according to claim 1, wherein at least one of the main filter element and the prefilter element comprises a polygonal form or a cuboid form.

18. The ambient air purification device according to claim 1, wherein the filter device is arranged at a suction side in relation to the air flow generating device.

19. The ambient air purification device according to claim 1, wherein the plurality of filter medium bodies of the main filter element comprises at least four filter medium bodies.

20. The ambient air purification device according to claim 19, wherein the at least four filter medium bodies each have a filter surface area of 0.5 m² to 3.5 m².
